(19) United States
(12) Patent Application Publication
(10) Pub. No.: US 2016/0260232 A1
(43) Pub. Date: Sep. 8, 2016

(54) SYSTEMS AND METHODS FOR CREATION OF VISUALIZATIONS

(71) Applicant: Digizyme, Inc., Watertown, MA (US)

(72) Inventor: Gaël-Christophe Garth McGill, Brookline, MA (US)

(21) Appl. No.: 14/639,456

(22) Filed: Mar. 5, 2015

(51) Int. Cl. G06T 11/20; G06T 13/80; G06T 7/00

(52) U.S. Cl. CPC G06T 11/20; G06T 7/0012; G06T 13/80

(57) ABSTRACT

The invention provides image, animation, and simulation generation tools that do not require expertise with 3D animation techniques, which tools can be used by scientists to create visualization products that illustrate different aspects of cellular and molecular biology and other scientific phenomena. A web portal or UI is used to receive user input and return the visualization products. Systems of the invention may create the visualization products using models from a database in which each model includes scientifically accurate structural data as well as an animation rig defining dynamics for the modeled structure. The structural data and the rigs are built based on scientific information. The curated models can be used in creating images, animations or interactives. The structural data provides that depicted objects will be scientifically accurate and the animation rigs provide scientifically accurate range-of-motion or dynamic information so that the animations will illustrate interactions accurately.

### FIELD OF THE INVENTION

The invention relates to systems and methods for creation of visualizations.

### BACKGROUND

Scientists typically rely upon a range of visual depiction conventions and strategies to describe different aspects of cellular and molecular biology. For example, visual representations are often used to facilitate a person's leaning of a scientific concept. Illustrations, diagrams, animations, and interactive learning tools are increasingly used in classrooms and at scientific gatherings to make sense of molecular and cellular phenomena.

However, the visual tools currently being used are not necessarily well-suited to the scientific concepts being taught. For example, proteins are typically shown as static representations outside of their cellular context. However, evidence indicates that proteins are dynamic shape-shifting entities that are constantly exploring the thermodynamic landscape available to them. Their association and dissociation from partner proteins involve a range of conformational states that are critical to their function. Accordingly, many currently used visualizations represent scientific phenomena with deceptive clarity, offering an oversimplified, sometimes inaccurate, explanation of a scientific concept for the sake of simplicity.

Existing software tools do not permit the scientific and educational community to readily prepare more sophisticated visual renderings that can depict the dynamic motion of biological entities interacting in their environment. Rather, simplified representations are often borrowed from independent sources and not contextualized to the scientific concept or to the audience.

The scientific and educational communities must resort to such tactics because sophisticated animation software is not easily created or learned. Currently, a person has limited options for creating sophisticated animated visual content. The person can either build the visual content themselves or contract to have it built. Neither is a practical solution. Building the content requires significant experience with 3D animation software, which most scientists and educators do not possess. Contracting is expensive and only results in a single visualization product being produced.

### SUMMARY

The invention provides image and animation generation tools that do not require expertise with 3D animation techniques, which tools can be used by scientists to create visualization products that illustrate different aspects of cellular and molecular biology and other scientific phenomena. The user can supply models such as crystal structures or can work with models available through systems of the invention. The user gives various input parameters using, for example, a web-based user interface (UI) and the system can return professionally rendered illustrations and animations. By these means, systems of the invention allow for a do-it-yourself approach in which a user can easily and cost effectively build an animation that depicts scientific concepts, such as concepts of cell and molecular biology, that are properly contextualized to an audience. Accordingly, the system serves as a starting-point not only for an experienced scientist-animator (who can save time and increase the accuracy of their work), but also for a person who has a scientific background but lacks any experience in animation or visual arts (in that the system allows them to easily build a customized scientific image, animation or interactive without any technical knowledge).

Aspects of the invention are accomplished by using a web portal or UI to receive user input and return the visualization products. Systems of the invention may create the visualization products using models from a database in which each model includes scientifically accurate structural data as well as an animation rig defining dynamics for the modeled structure. The structural data and the rigs are built based on scientific information. The curated models can be used in creating images, animations, or interactives. The structural data provides that depicted objects will be scientifically accurate and the animation rigs provide scientifically accurate range-of-motion or dynamic information so that the animations will illustrate interactions with desired accuracy. Since the structures and the rigs are curated and stored in a database, the system can use them as-is—that is, the curated models are “ready for use” in building animations. The user need not manipulate the files to confer accurate dynamics on the depicted structures. Entries from the curated model database can be imported into an animation platform to create animations that may be used, in turn, to create digital media such as still images, videos, games, simulations, or other interactive media. Thus, a scientist can use the web portal system to create media that depict scientific phenomena that are being studied. Since the database entries use data sourced from scientific studies, accuracy is not sacrificed when building visual media.

In certain aspects, the invention provides a method for providing a visualization product. The method includes receiving, at a server system, input from a user that identifies one or more biological entities and a biological concept involving the one or more biological entities. The server system automatically constructs a visualization product that uses at least one digital asset and that visually conveys the biological concept. For example, the visualization product may show an interaction of the biological entities. A displayable form of the visualization product is output for viewing by the user. In certain embodiments, the digital asset includes a structure and a rig that defines animation dynamics for the structure. Moreover, the system may select a rig for use from a set of alternative riggings. A web portal may be used to receive the input and display the output.

The user input may include instructions for tailoring the visualization product. For example, based on the instructions, the system may tailor the visualization product by using additional assets to depict a biological context for the one or more biological entities. The system may construct the visualization product by selecting a plurality of digital assets that includes the at least one digital asset for use in constructing in the visualization product.

The input from the user may include a selection of a setting for the display such that the system causes the user device to provide the display according to the selected setting. The system can control the display setting for perspective, an animation setting, a color setting, or other such settings. The visualization product may be an animation depicting an interaction of at least two biological entities.

Aspects of the invention provide a system for providing a visualization product. The system includes a processor coupled to a memory and is operable to receive input from a user that identifies one or more biological entities and a biological concept involving the one or more biological entities. The system automatically constructs a visualization product that comprises at least one digital asset and that visually conveys the biological concept, e.g., showing an interaction of the biological entities and the system outputs, to a user device, a displayable form of the visualization product for viewing by the user. The digital asset may use a structure and a rig that defines animation dynamics for the structure. The system may operate by providing a web portal for use by the user and receiving the input and outputting the display through the web portal.

The system may tailor the visualization product (e.g., according to tailoring instructions in the user input) by using additional assets to depict a biological context for the one or more biological entities. The system may select a plurality of digital assets that includes the at least one digital asset for use in constructing in the visualization product. The system may cause the user device to provide the display according to a selection of the user. The system can select the rig from among a set of riggings. In some embodiments, the visualization product is an animation depicting an interaction of at least two biological entities.

### BRIEF DESCRIPTION OF THE DRAWINGS

FIG. 1 diagrams of a method for providing a visualization product.

FIG. 2 shows a server system operable to construct the visualization product.

FIG. 3 shows the queueing and submission process in closer detail.

FIG. 4 shows an exemplary visualization product.

FIG. 5 illustrates how the server system may build up a visualization product using visual layers.

FIG. 6 shows output of the system.

FIG. 7 gives an exemplary structure of a rigged model.

FIG. 8 depicts a model representing a reovirus signal protein.

FIG. 9 illustrates one method of rigging a model.

FIG. 10 shows altered conformation of a model based on the applied rigging.

FIG. 11 shows a web portal provided by the server system for use by the user.

FIG. 12 illustrates tailoring a visualization product.

FIG. 13 illustrates a lipid bilayer in the context of a endosome within a cellular context.

FIG. 14 shows use of systems of the invention.

FIG. 15 shows use of a menu for selecting settings.

FIG. 16 illustrates bringing molecule models into a membrane model.

FIG. 17 shows use of an electronic device to view a visualization product.

FIG. 18 gives another example of a visualization product that may be produced.

FIG. 19 illustrates the use of a device to interact with a model of a natural system.

FIG. 20 illustrates a computer system for systems of the invention.

### DETAILED DESCRIPTION

Systems and methods of the invention provide automated, cloud-based image and animation-generation tools. A user such as a scientist can interact with a user interface (UI) such as a web portal provided by the system to give input that the system uses to automatically create a visualization product such as an image, a video, an interactive or an animation. The system creates the visualization product automatically, drawing on resources such as a database of structures for biological entities, and can create the visualization product using 3D computer animation or simulation principles such as rigging for structural models to create a realistic visualization product that is tailored according to any instructions from the user. The user need not have knowledge of 3D animation software to take advantage of the system's build-your-own-animation capabilities.

Systems of the invention may offer a variety of useful functions. For example one tool allows a user to create a binding animation of two molecules (A & B). The user may supply or specify a PDB co-crystal, select molecular representation style, color, motion style and positioning of molecules A and B at both the start and end of the animation. The user submits these choices via a web UI and the system sends back a professionally rendered animation.

In another example, the system may provide tools such as a series of image- and animation-creation functionalities that recapitulate what existing molecular visualization software in the scientific community can achieve (such as Chimera and PyMol) but implemented in an automated, made-to-order production environment. A user may submit a PDB ID, customize a look by selecting representation, color, motion, etc., via preset, and have the system send back to the user an animation. For example, the animation could include a turntable style display of the molecule or molecular complex.

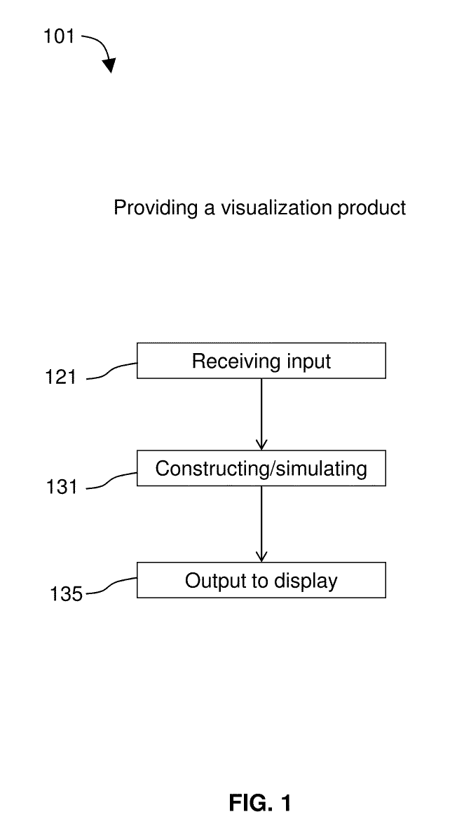

FIG. 1 diagrams of a method 101 for providing a visualization product. The method includes receiving 121, to a server system, input from a user that identifies one or more biological entities and a biological concept involving the one or more biological entities. The server system automatically constructs 131 a visualization product using a digital asset that visually conveys the biological concept. The visualization product can show, for example, an interaction of biological entities. A displayable form of the visualization product is output 135 to a user device for viewing by the user.

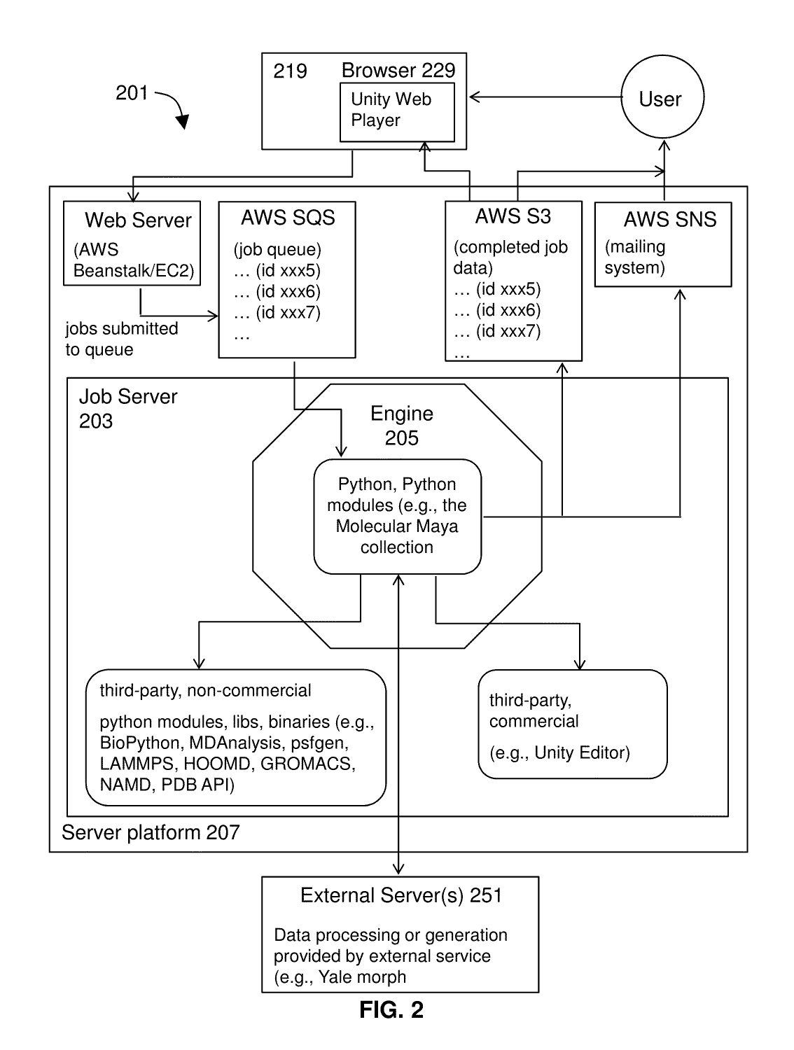

FIG. 2 shows a server operable to construct 131 the visualization product. User input is received through, for example, the user's use of a web browser 229 on device 219. In some embodiments, the user uses the web browser to access a web player for a 3D engine such as the web player sold under the trademark UNITY by Unity Technologies (San Francisco, Calif.).

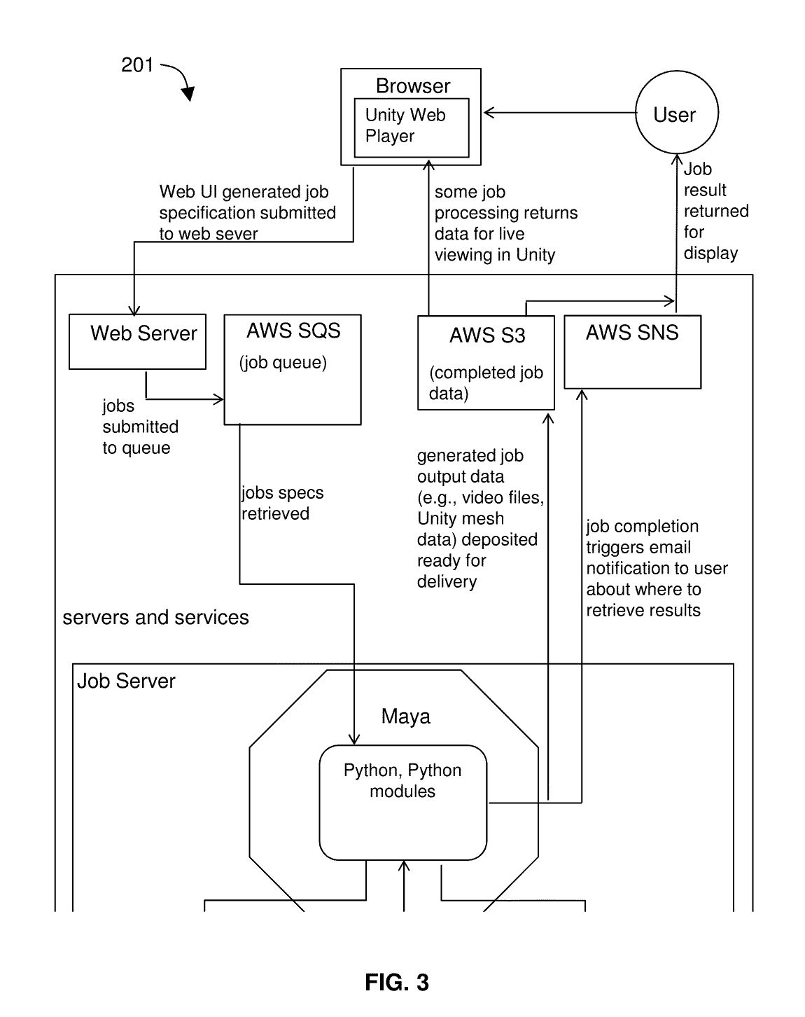

FIG. 3 gives more detail of system 201 and the queueing and submission process the system provides. Server system 201 receives the input and uses a queue service to submit the job to a job queue. One such queueing service is simple queue services (SQS) offered by Amazon Web Services, Inc. (Seattle, Wash.). The job queue submits jobs to a job server 203 that operates to construct 131 the visualization product. With reference back to FIG. 2, the job server 203 draws on a number of resources such as optional third-party modules and external servers that support operation of the construction using an animation engine 205 such as the 3D animation software offered under the trademark MAYA by Autodesk Inc. (San Rafael, Calif.). The animation engine 205 can use software of any suitable architecture. For example, in some embodiments, the animation engine 205 uses Python and Python modules such as the software toolkit Molecular Maya available from Digizyme, Inc. (Watertown, Mass.). The animation engine 205 uses the user input to draw upon appropriate services such as third-party or external services. Loaded within the job server 203 may be such third-party products and BioPython or the United Editor. Additionally or alternatively, the animation engine 205 may call on outside services 251 such as a database of molecular movements such as the database of molecular movements known as Yale Morph. Using such resources, the job server constructs 131 the visualization product as described herein. Preferably, the job server creates a visualization product using at least one digital asset, which can show biological entities and their interactions.

Any suitable biological entity can depicted, as can the interactions between or among such entities. Exemplary biological entities and interactions that can be illustrated include protein binding and conformational changes, fluid flow and dynamics, biomolecular interactions, biomolecule synthesis or degradation, or others. For example, an interaction between DNA and histone proteins can be illustrated.

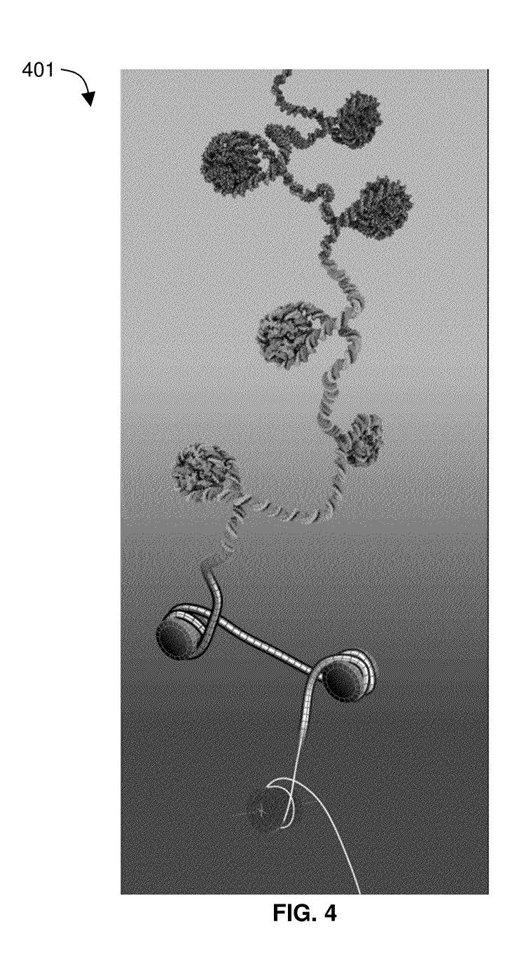

FIG. 4 shows an exemplary visualization product 401 that uses at least one digital asset and that visually conveys the biological concept showing an interaction of the biological entities. Here, the packaging of DNA into chromatin by the interaction of DNA with histones is illustrated. The job server 203 constructs 131 this visual product automatically upon the input from the user and outputs 135 a displayable form of the visualization product to a user device for viewing by the user. The visualization product 401 can be constructed using tools such as layers, rigging, others, and combinations thereof. Layers allow products to be constructed with appropriate detail at various foreground to background levels within an image. Animation concepts such as rigged structures allow animation to be depicted.

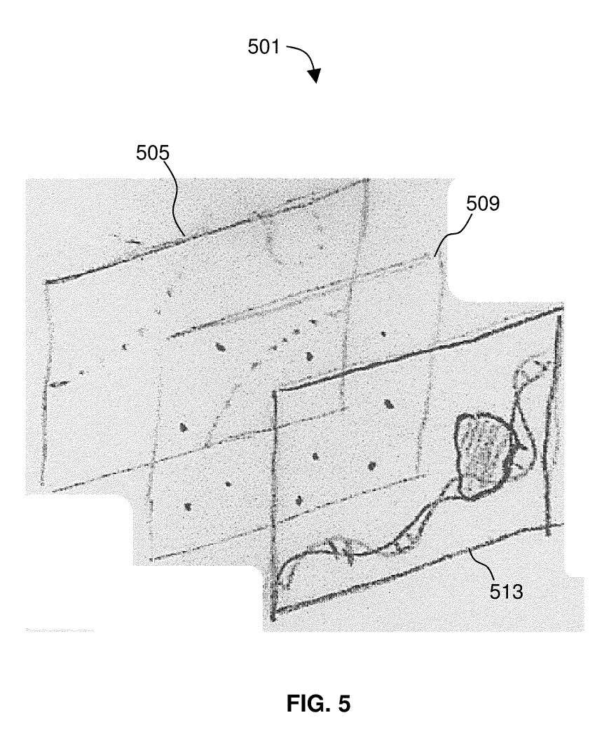

FIG. 5 illustrates how the server system may build up a visualization product, here depicted using a layered structure 501. In some embodiments, a layered structure 501 is used for conveying a scientific concept. The layered structure 501 can include at least a back layer 505, a mid-layer 509, and a front layer 513. The layered structure 501 provides a tool which the job server can organize the visualization product during construction 131. Any suitable scientific concept can be depicted using layered structure 501. For example, transcription factor binding can be illustrated by having back layer 505 provide a nuclear backdrop. Mid layer 509 can include environmental proteins as actors (e.g., one or more miscellaneous DNA-binding transcription factors). Front layer 513 will generally include primary actors such as the “hero” protein, here, a transcription factor bound to DNA. Using multiple layers can result in the creation of a complex visual product assembled from several simple visual layers. Using different layers can also aid in automatically tailoring a visual product to the educational level of an audience. For example, where it is desired to teach simply the wrapping of DNA around histones, the back layer 505 and mid layer 509 can be put into soft focus so that the student's attention is given to the front layer 513. Alternatively, a level of detail in mid layer 509 can be increased for, for example, a journal publication about binding factors where the audience will typically have a post-doctoral education level. Using at least one rigged model 121, a visual product can be made—such as an animation, interaction, simulation, game, a photo-quality still, or similar material—that can be used to illustrate a scientific concept. The visualization is output 135 in a displayable form to a user device for viewing by the user.

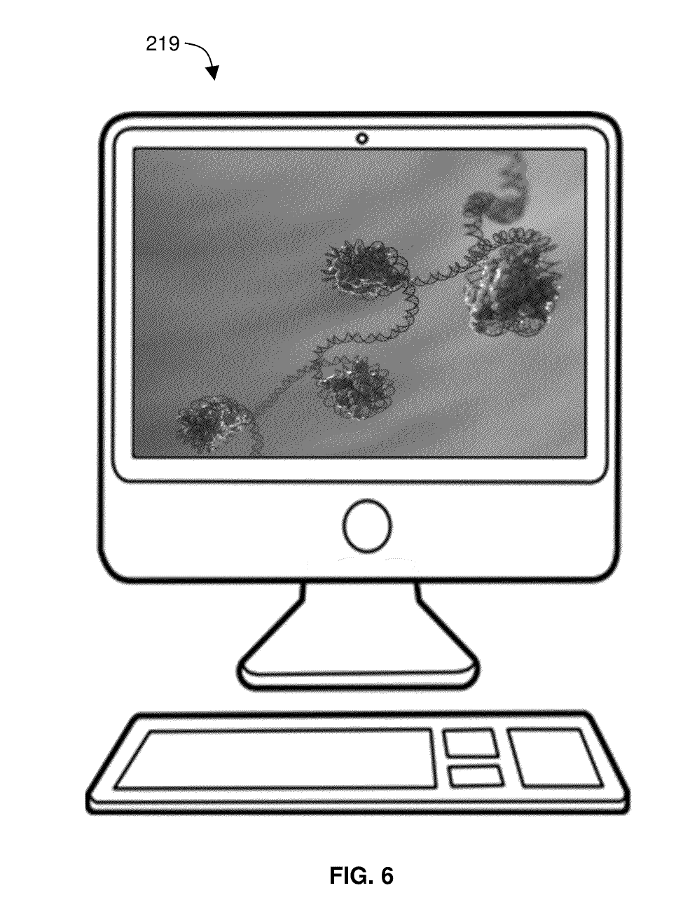

FIG. 6 shows output on device 219 from the outputting 135 step. Since layers are used and since material is represented using rigged models, the image in FIG. 6 provides a visual product that conveys a scientific concept with accuracy. The visualization product can be tailored in any suitable way. For example, the visualization product can be tailed to an education level of an audience. Additionally, as discussed above, the job server can use 3D animation techniques to depict one or any number of entities using a digital asset that provides a rigged model. A rigged model preferably includes a structure and a rig that defines animation dynamics for the structure.

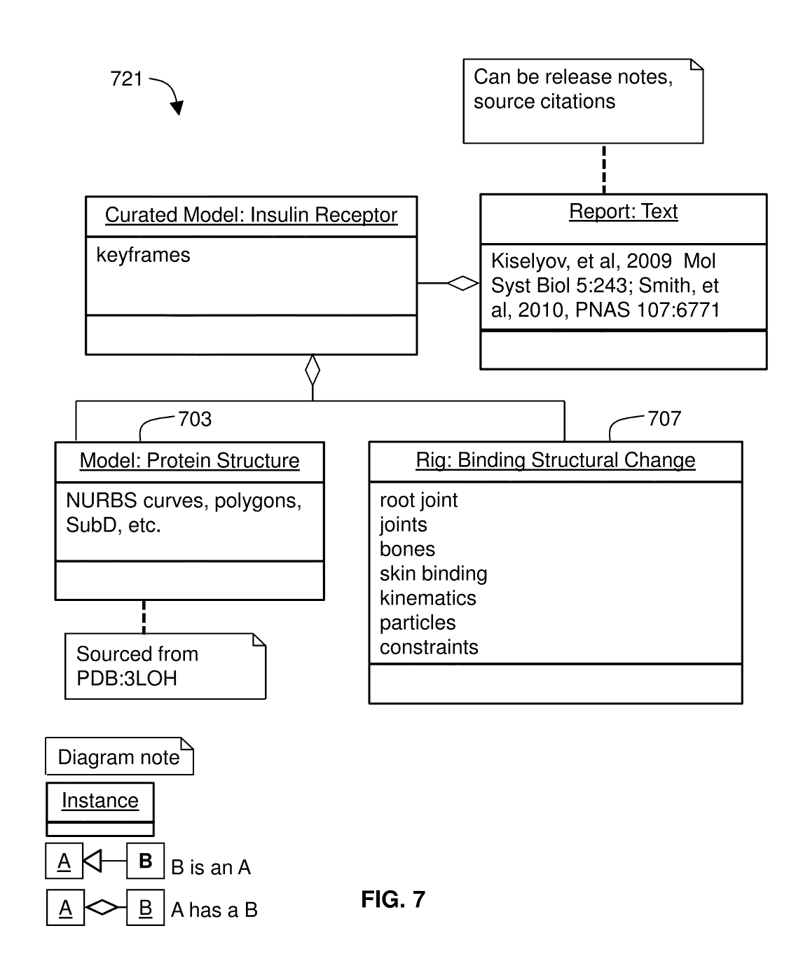

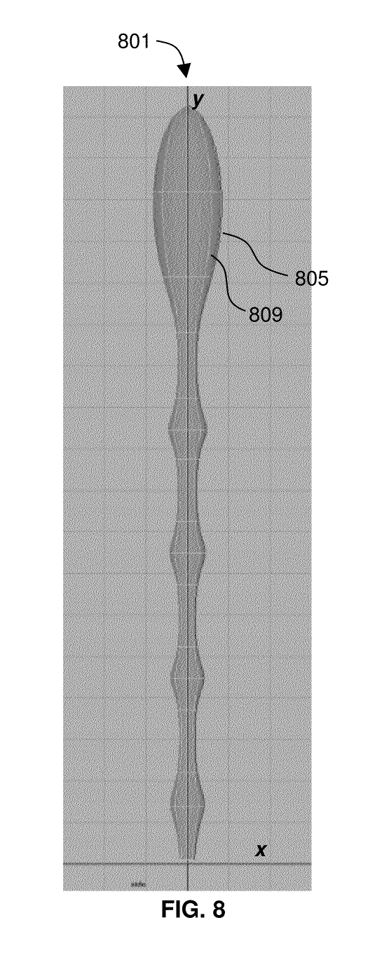

FIG. 7 gives an exemplary structure of a rigged model 721. A rigged model 721 will generally include a model 703 and a rig 707. A rig is known in the art of 3D animation and generally refers to a 3D construct that provides an organized system of deformers, expressions, and controls applied to a model and that specifies and drives the motion of the model so that it can be effectively animated or simulated. A rig may include joints, bones, particles, springs, constraints or other concepts. Rig has been used in the animation arts to include a deformation engine that specifies how movement of a model should translate into animation of a depicted entity based on the model. A rig provides software and data used to deform or transform a neutral pose of a model into a specific active pose variations. By having animation software manipulate a rig incorporated to a model, animated or simulated movement of the model is achieved. Rigging may sometimes be referred to as character setup or animation setup. A detailed discussion of creating rigs may be found in sources such as O'Hailey, 2013, Rig it Right! Maya Animation and Rigging Concepts, Focal Press, Burlington Mass., 280 pages; Palamar and Keller, 2011, Mastering Autodesk Maya 2012, Wiley Publishing, 950 pages (esp. chapters 5 and 7); and Sharpe, et al., 2008, In silico: 3D Animation and Simulation of Cell Biology with Maya and MEL, Elsevier Morgan Kaufman, Burlington, Mass. (622 pages), the contents of each of which are incorporated by reference. Rigging and rigs are discussed in U.S. Pat. No. 8,253,745 to Hahn; U.S. Pat. No. 7,782,324 to Goldfarb; U.S. Pub. 2013/0235046 to Lanciault; U.S. Pub. 2011/0098113 to Lanciault; U.S. Pub. 2009/0295793 to Taylor; U.S. Pub. 2009/0091563 to Viz; and U.S. Pub. 2006/0109274 to Alvarez, the contents of each of which are incorporated by reference. Rigging is discussed in greater detail below (e.g., with respect to FIGS. 8-10).

Model 703 includes data representing a structure, often in the form of a geometry file or particle cloud/object. Any suitable model 703 may be included in a rigged model 721. The model may represent a single molecule, an assembly of molecules, or a structure or systems. Examples of things that may be represented by a model include a protein, a nucleotide, a polymerase bound to a strand of DNA, a solar system, a skeleton, a machine, or others. In some embodiments, model 203 is a geometry or particle object file(s) of a format suitable for creation, viewing, and manipulation within modeling or animation software such as, for example, Autodesk Maya. Any suitable animation software may be used. Exemplary animation software products include those provided by Cinema4D Studio by Maxon Computer Inc. (Newbury Park, Calif.), Blender supported by the Stichting Blender Foundation (Amsterdam, the Netherlands), and 3DS Max 2014 by Autodesk, Inc. (San Rafael, Calif.).

Any suitable method may be used to obtain a geometry or particle file. For example, the information necessary to create geometry or particle files can be imported from sources such as structure database, created de novo within a modeling environment, or built of raw data obtained from an experiment or assay. The structures to be represented by geometry or particle files may be predicted by computational algorithms, or may represent real structures determined by spectroscopic methods such as X-ray crystallography or nuclear magnetic resonance (NMR).

One exemplary approach to obtaining geometry files includes the use of a molecular graphics application such as Chimera or PyMOL. Other suitable applications may include Astex Viewer, UGENE, DS Visualizer, Swiss PDB Viewer, Interchem, VMD, RasMol, Jmol, Python Molecular Viewer, Coot, MDL Chime, MolS oft Viewer, and other such products. Such a program can be used to open raw structural data, such as a set of coordinates from a protein databank (PDB) file and to export the structural data in a format suitable for use in a modeling environment. Raw structural data can also be used to generate a particle file for use in a modeling, animation or simulation environment.

A PDB file embodies a format for representing actual 3D structures of biological molecules. The PDB format is widely accepted as a standard in the biosciences. The molecules may include protein, nucleic acid (RNA or DNA), lipids, carbohydrates, other molecules or macromolecules, a complex of several proteins, a complex of protein with nucleic acid, or any combination thereof including but not limited to these in a complex with small molecule ligands such as drugs, cofactors, metal ions, etc. The 3D structure of the macromolecule is usually determined by X-ray crystallography, but other spectroscopic methods, such as NMR, or microscopic methods, such as cryoEM, are occasionally employed. The Protein Data Bank currently archives close to 100,000 PDB files of molecular structures, which are freely available to the public. See, e.g., Berman, et al., 2000, The Protein Data Bank, Nucl Acids Res 28(1):235-242.

The PDB format includes ASCII text giving XYZ coordinates for atom locations, as well as data on atom-to-atom bond connections. Other information typically included are protein amino acid sequence and secondary structure, crystallographic space group, and general comments on the biological role of the protein. Molecular graphics applications such as Chimera or PyMOL by design readily import PDB files.

The structural data can be exported from the molecular graphics application (e.g., Chimera, PyMOL) to generate geometry files. These may be exported as Virtual Reality Modeling Language (VRML) and then converted to OBJ format (a common data format for 3D data) before being imported into a modeling program such as Maya. Additionally or alternatively, scripts can be used to prepare a geometry file from a set of coordinates using, for example, Maya Embedded Language (MEL). The method to use may relate to what will be done with the geometry once inside Maya. In certain embodiments, large PDB datasets are brought into Maya as geometry files using the multi-scale model feature of Chimera.

In some embodiments, structural data can be obtained for modeling using products like the Molecular Maya Toolkit, sometimes referred to as mMaya or Molecular Maya, the embedded Python Molecular Viewer, sometimes referred to as ePMV or BioBlender. Molecular Maya is a free software toolkit that extends the capabilities of Maya by allowing users to import, build, and animate molecular structures. Molecular Maya includes the functionality to open PDB and other formatted files. Molecular Maya works with Maya 2011, 2012, 2013, and 2014 and adds a molecule-shaped icon to the Maya environment. Molecular Maya includes (or adds to Maya) UI elements for opening PDB files. Molecular Maya can import the text-formatted native PDB file.

Typically Maya, or Molecular Maya, will obtain a model to work with such as by, for example, importing a PDB file. Once a PDB file is imported, it can be represented as atoms. However, Molecular Maya can transform it into a geometric or particle structure, with options for selecting levels of resolution. Once imported, the geometry and/or particle file provides the model 703 for a rigged model 721. Molecular Maya draw from a range of structural pieces to automatically create model 703 or a model 721.

FIG. 8 depicts a model 801 representing a reovirus signal protein. Reovirus attaches to cellular receptors with the signal protein, a fiber-like molecule protruding from the 12 vertices of the icosahedral virion. The receptor-binding fragment of signal includes an elongated trimer with two domains: a compact head with a beta-barrel fold and a fibrous tail containing a triple beta-spiral. See Chappell, et al., 2002, Crystal structure of reovirus attachment protein signal reveals evolutionary relationship to adenovirus fiber, EMBO J 21:1-11. Model 801 can be made by any suitable method such as, for example, approximating the outer surface of the molecule by drawing a NURBS curve and rotating it around the Y axis. In some embodiments, model 701 is made by importing data from a PDB file, specifically from PDB #1KKE. A PDB file can be imported directly into a program such as molecular Maya or a PDB file can be opened in a viewer (e.g., PyMOL) and exported as VRML which can then be opened by a program such as Maya or Molecular Maya to arrive at model 801 as shown in FIG. 8.

Model 801 represents one subunit of the signal trimer and the beta-barrel head and fibrous tail are visible. That structure is represented here as a plurality of NURBS curves 805 defining a surface 809. This model 801 provides the geometry file that can be rigged for animation.

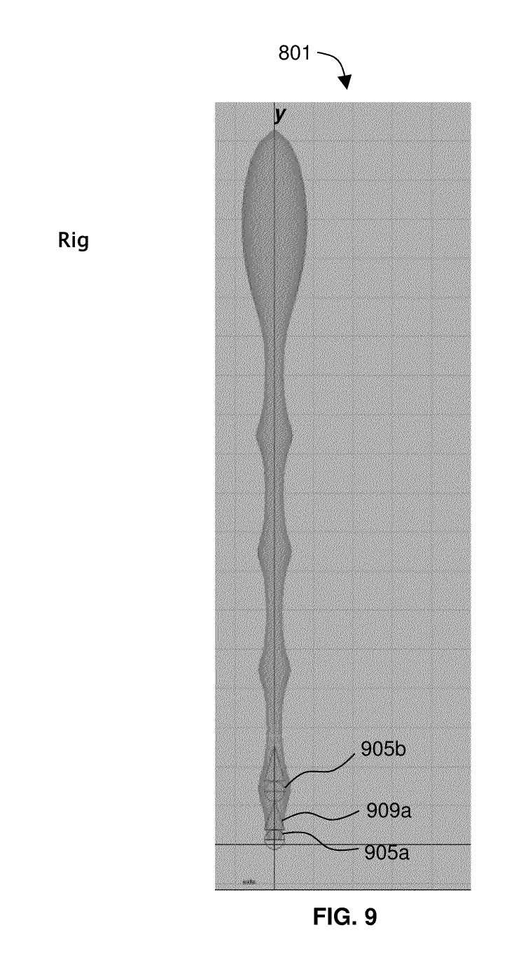

FIG. 9 illustrates rigging model 801. Rigging includes the creation of organized systems of deformers, expressions, and controls applied to an object so that it can be animated well. A rig will allow an animator to create an animation without himself doing the rigging. That is, rigging is uncoupled from animation or simulation, allowing different tasks to be performed by specialists. As one of skill in the art will recognize, rigging is a continuously evolving practice. Typically, rigging will include starting with a geometry or particle object such as model 801, building a skeleton, creating the rig and weighting the geometry.

The skeleton is built by adding joints 905 to model 801. Rigging can include using Maya's Joint Tool from the Animation menu to create a skeleton when, for example, beginning work on a geometric structure. For example, if protein is modeled as a mesh, and a scientist wishes to illustrate conformational changes upon binding, the Joint Tool can be used to introduce joints into the mesh, which will be connected by bones 909 (here, bones, joints, and skin refer to the control tools known in the animation arts). Joints are oriented in that their axis (e.g., defining the pivot) is oriented appropriately. Typically, orienting is done before the geometry is bound to the skeleton. In Maya, a joint will be represented by a wireframe sphere. Joints are connected by bones 909, which are represented by wireframe pyramids with the point pointing towards the child when joints 905 are parented together. Generally, a bone 909 will extend between a parent and a child joint 905. A skeleton can be assembled to correspond substantially to a skeleton as known in zoology, however a skeleton more generally represents a structure for animation. In fact, a strength of the animation methods described herein is that the skeleton need not match the natural skeleton. A skeleton may be bound to a skin so that, when bones and joints of a skeleton move (e.g., according to inputs and a rig), the skin presents a visible surface that deforms (e.g., according to how it is bound to the skeleton). As seen in FIG. 9, first joint 905a is created at the end of the fibrous tail of the monomer. When second joint 905b is created, bone 909a is created extending from first joint 905a to second joint 905b. This process is continued for all of model 801.

Methods may include skinning the geometry of model 801. Skinning geometry is the process in which geometry is bound to joints so that, as the joints are rotated or translated, the geometry is deformed. The terms skinning and binding are generally interchangeable. Any type of binding by may be used such as, for example, smooth binding, interactive skin binding, and rigid binding. When geometry is smooth bound, each vertex of the geometry receives a weighted influence from the joints 905. Interactive weighting allows the rigger to set weights by entering them. Typically, the skeleton is bound to the geometry with the skeleton in the bind pose.

Once geometry has been skinned to a skeleton of joints, a system of controls is created to make animating the joints as simple as possible. Controls can be created from locators or curves or any other node that can be selected in the viewport. Other types of deformers may be used besides joint deformers and may include influence objects, lattice deformers, Maya Muscle, and other tools. Using bones and joints created during rigging, parts of a model can be moved with scientific accuracy.

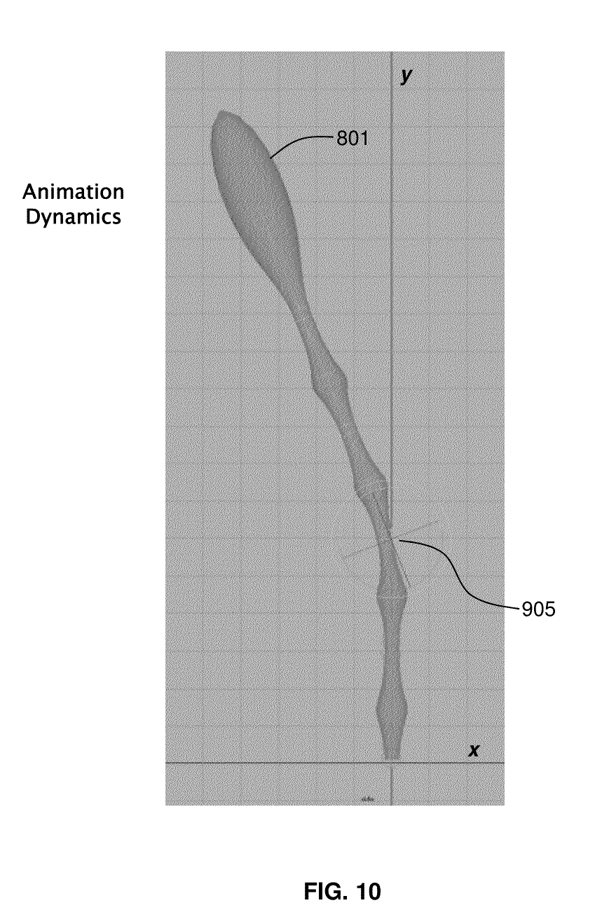

FIG. 10 shows a motion of a model 801 based on the applied rigging. The signal monomer has bent around joint 905. Rotation around joints can be controlled by kinematic concepts, as provided for within animation environments such as Maya and molecular Maya.

Such animation environments provide for controls such as forward kinematic and inverse kinematic controls of systems of joints. Forward kinematics refers to having each joint in a chain inherit the motion of its parent joint, while inverse kinematics (IK) refers to causing joints to orient themselves based on the location of a goal known as an end effector. For example, an amino acid side chain in the active site of an enzyme may be rigged with inverse kinematics using the substrate as the end effector. A protein subunit that undergoes a tertiary structure re-organization while changing conformations may be modeled using forward kinematics.

In some embodiments, animation involves the use of deformers such as blend shapes. A blend shape deformer allows a depicted structure to morph between two meshes and allows a user to control the blend and the morph. Typically, at least two topologically identical meshes are created, representing the structure in at least two corresponding conformations. A blend shape is created from the meshes and a node network is created that will work with constraints and rig controls to adjust the animated transformation between the two conformations. In Maya, the two meshes are selected and the Blendshape command is run from the Create Deformers menu. A new node is created and one of the meshes can be deleted (now being represented by the Blendshape).

Preferably, a rigged model includes an animation rig that is easy to understand. For example, controls are labeled and easy to select. For any handle, entering 0 in the translation channels for the controls return the rig to the start position. IK handles use world space coordinates so setting translation channels to 0 moves the handle to origin. These and other principles of good rigging will be understood by those of skill in the art. One valuable tool in rigging includes the use of set driven keys. Driven keys link attributes of one object to attributes of another. Setting driven keys can eliminate the need to move each of a plurality of parts independently.

The invention provides techniques that are suited for complex morphs that allow conformational states of proteins to be depicted. Using systems and methods of the invention, one may create animations that are based on actual data for protein dynamics to provide vibrations and degrees of flexibility that reflect the protein's actual range of thermodynamically-permissible motion. The actual structural data is fed into the geometry of the 3D model 703, and dynamic data informs the rig 707. Not only can rigged models provide a scientifically accurate range of motion for proteins and other structures, other benefits can be included such as collision detection or overlap prevention.

For example, systems of the invention may be operable to register and warn against impending self-intersections through the use of self-aware rigging techniques applicable to scientific structures such as biological macromolecules. For structures such as biological molecules, collision detection rigging can include the use of electrostatic forces (e.g., as mapped to the surface of a space-filling model). Application of such collision-detection rigging (i.e., abiding by electrostatic concepts providing that like-charged surfaces repel and unlike-charges attract) provides a set of simulation tools useful to create molecular vistas with semblance to what happens in nature.

In some embodiments, the one or a set of MEL scripts not only create Maya-native geometry directly from the PDB but also automatically create a rig that has some inherent motion constraints applied. The automatic rigging may be applied with different types of molecular representation (ball & stick versus cartoon for example would have very different ‘rules’ applied to constrain motion). A MEL script can apply certain rigging to certain structural motifs automatically and by default. For example, the peptide bonds of a polypeptide can be automatically rigged for realistic rotations. The rigged model can be provided for “fine tuning” by a user by hand.

In certain embodiments, information for the rig is obtained from a scientific data source. For example, the conformational dynamics data bank (CDDB) can be accessed to obtain information about possible conformations of a protein. A rig can be created to restrict the range of motion of the protein model to conformations allowed by the conformation data bank information. A MEL script can be used to automatically create that rig and apply it to the model based on CDDB data. The CDDB is described in Kim, et al, 2011, Nucl Ac Res 29:D451-5. Suitable databases for protein dynamics may be discussed in Liu & Karimi, 2007, High-throughput modeling and analysis of protein structural dynamics, Brief Bioinform 8(6):432-45.

Additionally, curated models of the invention are suited for employment in modern gaming engines. In many cases, the digital assets (models, textures, rigs) used to develop high-end games are created in packages like Maya. In like fashion, molecular-movie style animations are generated within an environment such as Maya for application within interactive molecular environments for educational purposes. Further, embodiments of the invention can use rigging concepts to depict motion through animation and can even be used to control levels of granularity at which motion can be depicted. For example, at one level, the overall motion of molecular structures within their environments can be shown, while at another level, motions at the atomic level can be depicted. As discussed above in connection with FIG. 2, the system constructs 131 the visualization product based on user input. User input is received through, for example, the user's use of a web browser. In some embodiments, the user uses the web browser to access a web player for a 3D engine such as the web player sold under the trademark UNITY by Unity Technologies (San Francisco, Calif.).

The invention provides image and animation generation tools that tools can be used to create visualization products that illustrate different aspects of cellular and molecular biology and other scientific phenomena. The “build your own animation” tools allow a user to create an animation that depicts, for example, binding and conformational change between two proteins or other such mechanisms. The user gives various input parameters using, for example, a web-based user interface (UI) and the system can return professionally rendered illustrations and animations. Aspects of the invention are accomplished by using a web portal or UI to receive user input and return the visualization products.

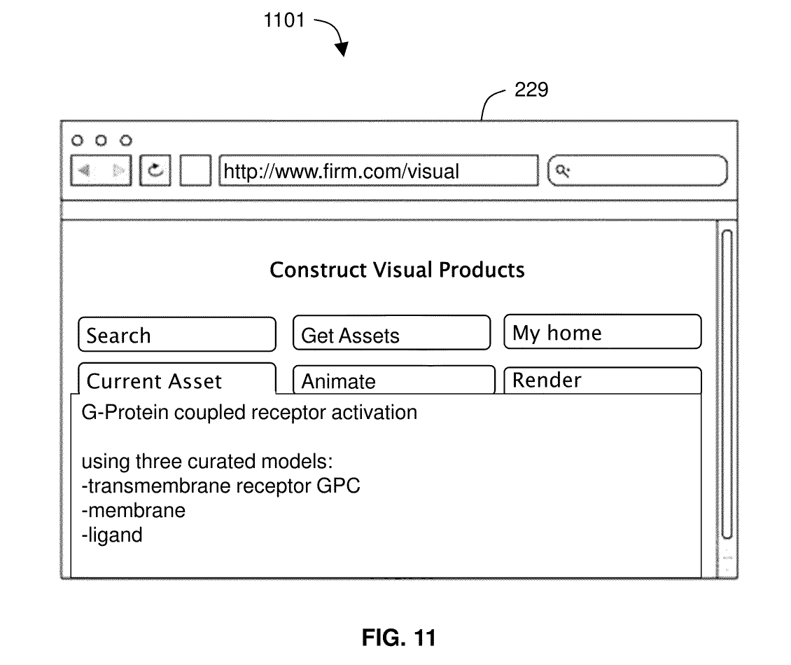

FIG. 11 shows a web portal 1101 provided by the server system for use by the user. The portal may be displayed by the user's web browser 129. The web portal can give the user tools for searching for entities to include in a visual product. Using the web portal, a user can inspect and manipulate digital assets for inclusion in a product. The web portal can connect to a curated model database such as the one described in U.S. patent application Ser. No. 14/220,647, filed Mar. 20, 2014, titled CURATED MODEL DATABASE and any pre-grant publication and patent arising from that patent application. The web portal can give the users tools to set up an animation and to specify a desired output type. By these means, systems of the invention allow for a do-it-yourself approach in which a user can easily and cost effectively build an animation that depicts scientific concepts, such as concepts of cell and molecular biology, that are properly contextualized to an audience. Accordingly, the system serves as a starting-point not only for an experienced scientist-animator (who can save time and increase the accuracy of their work), but also for a person who has a scientific background but lacks any experience in animation or visual arts (in that the system allows them to easily build a customized scientific image, animation or interactive without any technical knowledge). As shown in FIG. 11, systems and methods of the invention can employ a web front-end or other interface, such as a dedicated application, to allow users to create products described herein. Since databases, products, and visualizations described herein may include a large number and variety of unforeseen assets or model types (e.g., for things like a cell-type library), it is valuable for the invention to provide an easy-to-use interface for users to put in suggestions or requests. For example, a user can request their favorite cell type or a peroxisome. As depicted in FIG. 11, a user may see a web interface to set up a request for a visualization product that illustrates G-protein coupled receptor activation.

Any suitable scientific concept may be illustrated by systems and methods of the invention. For example, embryonic development can be illustrated and conveyed by modeling a developing embryo using one or more rigged model. In certain embodiments, one or more entire cell (e.g., substantially all components or processes) is depicted. Systems and methods of the invention have particular application to systems that include a stochastic component. For example, it may be illustrative to depict transmembrane proteins as drifting within a lipid bilayer membrane to communicate the fluidic mosaic model hypothesis of the plasma membrane. See, e.g., Singer & Nicholson, 1972, The fluid mosaic model of the structure of cell membranes, Science 175(4023):720-31. Using rigged models, each lipid can be populated to a membrane surface, and each transmembrane protein can be included, using a rigged model for each. Using methods of the invention as described herein, any of these scientific concepts and more can be illustrated. Additionally system 201 can be used to tailor the visualization product depending on the requirements of a particular project.

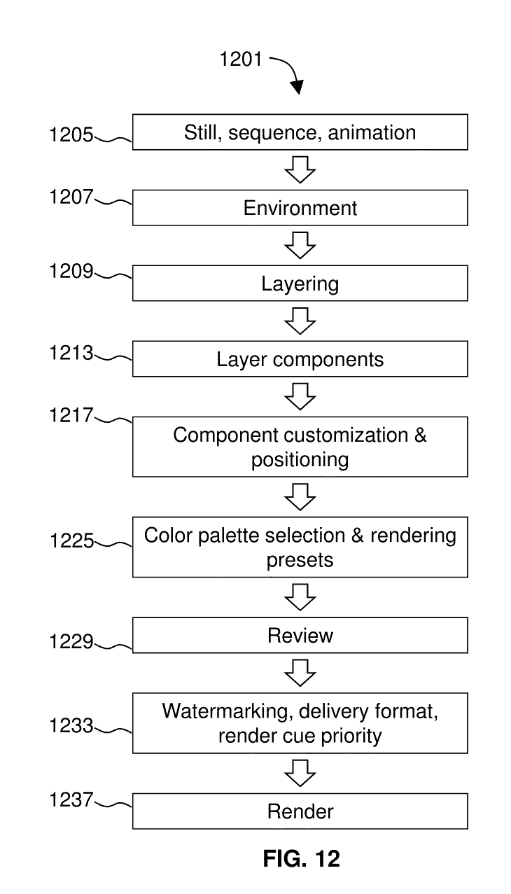

FIG. 12 illustrates tailoring 1201 the visualization product according to instructions provided with the input from the user. It is determined whether the visualization product will include a still, a sequence, an animation, others, or a combination thereof. The environment is determined (e.g., through the user's input). The animation engine 205 optionally performs a layering step that includes defining different layers for the visualization product. For each layer, the layer components for that layer are built by the animation engine 205. Layer component choices depend on the subject matter, the environment, and the layer. If a cellular biology concept is being communicated, options for components to have within various layers of the visual product may include none, nucleus, plasma membrane exterior, plasma membrane interior, mitochondrion, cytoplasm, others, or a combination thereof. The components are customized and positioned. One aspect of tailoring can include use of the animation engine 205 to employ a selected color palette and any rendering presets. Selecting color palettes can include assigning color by component or using an overall Kuler palette, and can also include using an overall image style (ambient occlusion (AO), simulated electron microscope (EM), cartoon-style, combinations). Ambient occlusion is a method to approximate light shining onto a surface. Typically, ambient occlusion is used for realism. Ambient occlusion provides a model of rays cast in every direction from a surface. Rays that reach the background increase the brightness of the surface, whereas a ray that hits an object contributes no illumination. As a result, points surrounded by a large amount of geometry are rendered dark, whereas points with little geometry on the visible hemisphere appear light. Programs such as molecular Maya include shaders such as the EM shader to simulate the appearance of electron microscopy. The process can include a review stage in which the user, in-house curators, or both review the visualization product for final deliver. System 201 can optionally watermark the product and provide the appropriate delivery format and can also set the priority (e.g., on-demand job before overnight orders). Finally, the animation engine 205 can be used by system 201 to render the final product.

As discussed above and throughout, systems and methods of the invention can be used to create a variety of digital assets, databases, and visual products. Systems and methods of the invention may include additional features and functionality. For example, a scientific animator my use a curated model to create a digital asset, which could, for example, depict and illustrate such diverse phenomena as polymerization, cell signaling, Brownian motion, lipid bilayer membrane structure, cellular organization, protein folding and conformation, organismal anatomy, embryonic development, bench-top lab experiment protocols, intracellular biomolecular structure and composition, viral structure and function including capsid packing, the biochemistry of metabolism, phylogenetics, ecological principles, neural function, and other phenomenon. For example, in some embodiments, a digital asset may illustrate polymerization. Individual monomers may be modeled and rigged so that they will self-assemble in an animation. In certain embodiments, a digital asset may illustrate Brownian motion. A curated model can be used for each of the individual particles (e.g., proteins, molecules, other physical particles), which may exhibit stochastic motion that is illustrated and modeled using the curated models.

As discussed above, the visualization product may be tailored according to the user input. Tailoring the visualization product may include using additional assets to depict a biological context for the one or more biological entities. To give an example, user input that describes a lipid bilayer can be tailored by the further inclusion of a cellular context, such as by depicting a cytoplasm and proteins within the cytoplasm that interact with molecules in the lipid bilayer.

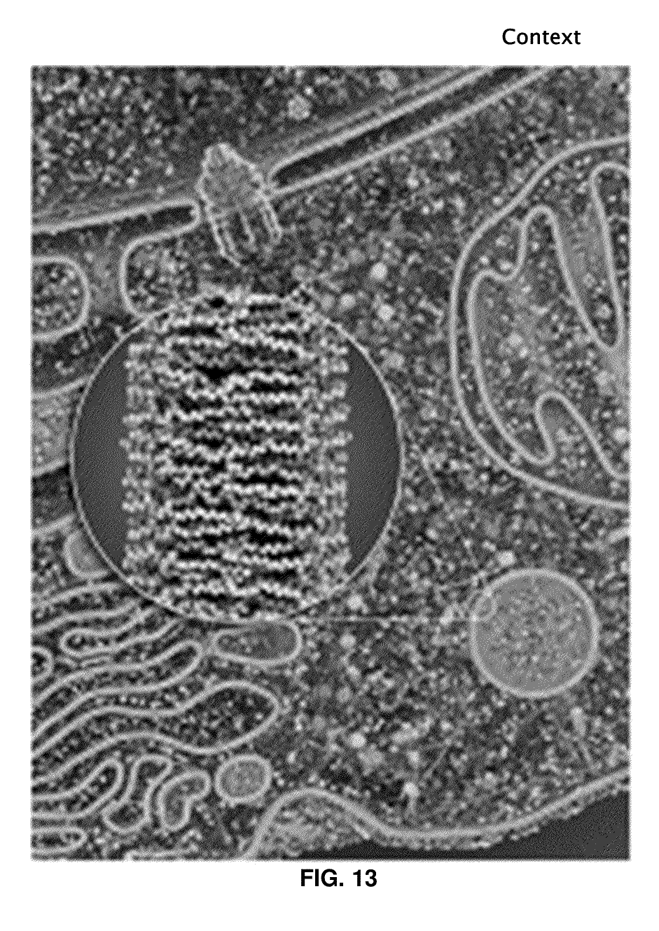

FIG. 13 illustrates a lipid bilayer in the context of a liposome within a cellular context. This illustrates that user may opt to depict a lipid bilayer. Through the use of, for example, menu options provided within the web portal UI, the user may select to include a cytoplasm to augment the depiction of the lipid bilayer. Adding context for a biological entity is one form of tailoring that may be provided by systems of the invention.

Systems of the invention may operate by selecting a plurality of digital assets for use in constructing the visualization product. For example, as mentioned above, the system can draw upon a curated model database for digital assets to be used in constructing in the visualization product.

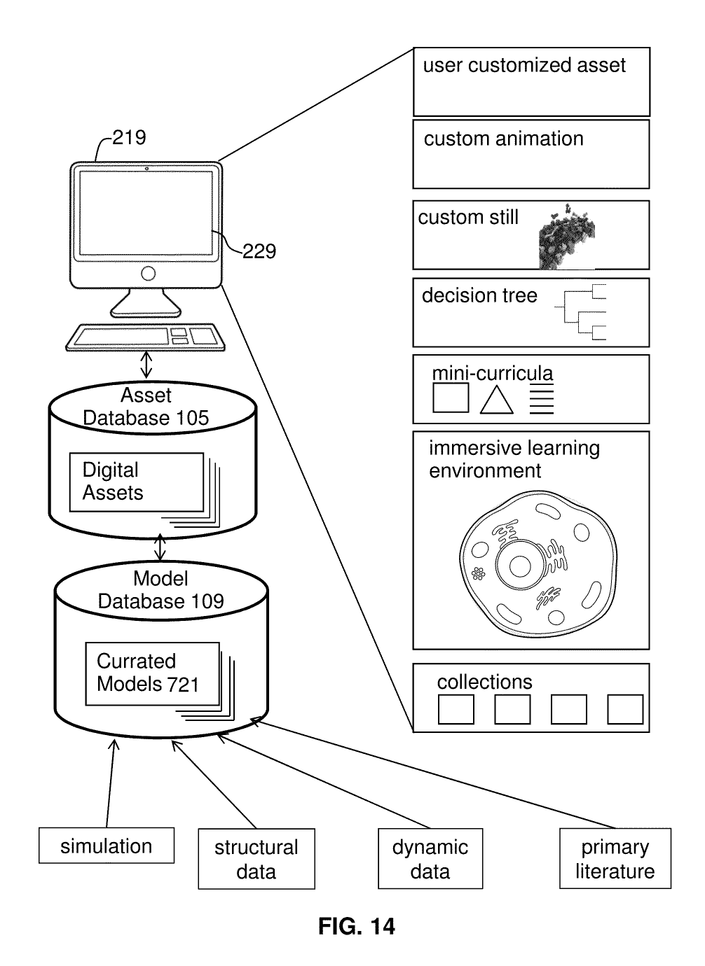

FIG. 14 shows systems of the invention that can be used to provide visual scientific content for example, as customized assets, animations, stills, interactive “decision-tree” visualizations, curricula, and immersive learning environments. The visualization product may be a single digital asset or a plurality of digital assets. The provided visual products may be described as curricula or animations, for example, but it can be understood that a plurality of digital assets is one general form of such a visual product. A visualization product may generally include a grouping of digital assets that explain a particular topic. One important type of visual product is a mini-curriculum. A mini-curriculum may refer to an organized group of digital assets supplemented with educator support materials, assessment materials, and other materials for use in the classroom or other educational context.

A visualization product that includes a plurality of digital assets may be made by drawing on an asset database 105. Digital assets within asset database 105 generally refer to an image, an animation, an interactive diagram, a mini-game, or such a piece of digital media. Generally, a digital asset will include one or more curated models from a curated model database 109. The present invention generally relates to curated model database 109.

Curated database 109 generally includes one or a plurality of rigged curated models 721. A curated model may generally be understood to refer to a 3D model of a molecule, organ, organisms, instrument or other that is constructed from multiple data sources (such as structural, dynamic and other sources) and rigged so as to be ‘scene-ready’ for production. A curated model may also include embedded within all the sources and techniques used in the modeling/rigging (and other curation) activities. Preferably, a curated model includes a multi-dimensional (e.g., 3D molecular) model that integrates scientific information (structural, dynamic, and other) that is ‘ready to use’ for visualization. Curated models 721 may be built de novo or by sourcing scientific data from a suitable source such as, for example, a simulation, structural data (e.g., from protein data bank), dynamic data, or the scientific literature. Curation includes selection or building of a model and rigging or simulating the model to produce a rigged or posed model 721. Rigging or simulating a model can make a model ‘ready to use’ for visualization. It is noted that a user for the curated model database may be a scientific animator (when models from the database are imported into a 3D app like Maya and then used to create a visualization, static or dynamic). One novel feature of a curated models database includes the way in which the models are accompanied by data which may specify (i) what pieces of a model were derived from what kind of data (X-ray vs. NMR vs. cryo-EM vs. modeled de novo using hypothetical data vs. others); (ii) the range of motion for a model as captured by one or multiple rigs (remembering that any given protein or other macromolecular model can have multiple rigs associated with it); (iii) domains/regions of the model associated with certain known biochemical behaviors; or others. For example, the model for a transmembrane protein may include—besides the structural data itself such as the shape(s) of the protein and its known range of motion—the transmembrane domain being flagged with metadata such that the protein embeds itself properly into a lipid bilayer when combined with a model or simulation of a lipid bilayer membrane. Another kind of data includes sites of post-translational modifications such as phosphorylation, glycosylation, or others.

Components of systems of the invention may be interacted with by a variety of different users. Non-limiting examples of users are given. The simulations, structural and dynamic data and primary literature that feed into model database 109 may be used by scientists or system administrators to make curated models 721. An animator may use model database 109 and the curated models 721 to create digital assets that populate asset database 105. A teacher, publisher, or content provider may use the digital assets to create custom animations, stills, mini-curricula, collections, and other media. End-users such as students, scientists, or the consumer public may use the custom animations, stills, mini-curricula, collections, and other media. It will be appreciated that any of the users or others may use any element of system 101.

In some embodiments, the input from the user further comprises a selection of a setting for the display and further wherein the user device provides the display according to the selected setting. Settings that can be controlled by the user input include perspective, animation, color, etc.

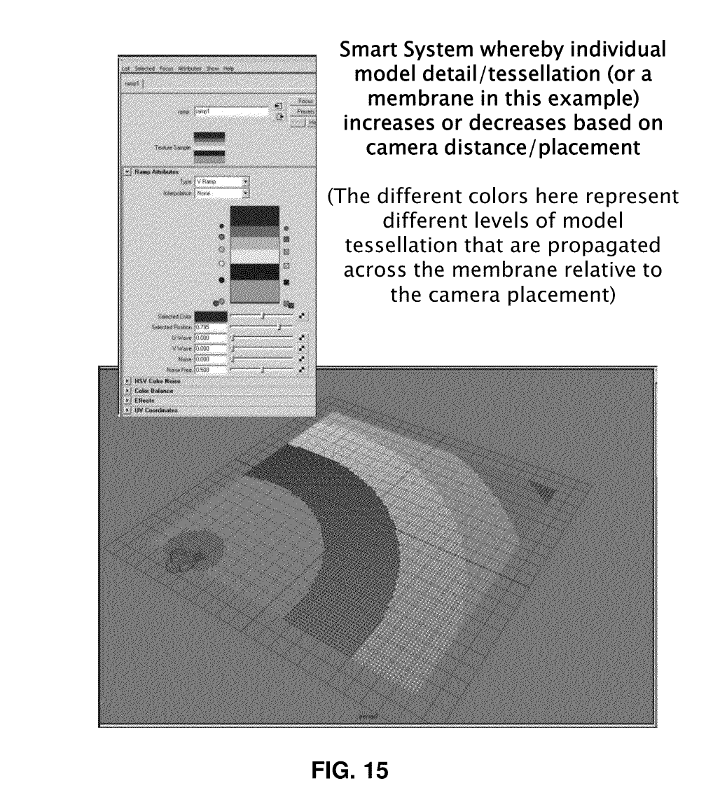

FIG. 15 shows use of a menu for selecting settings for regions across a membrane and set progressively varying properties across those regions. Here, a different level of detail is being set (e.g., high level of detail may be set for a region that will be close to a camera)—providing multiple levels of geometric (or other) detail is an example of metadata (i.e. an embedded property) of a curated model within the database.

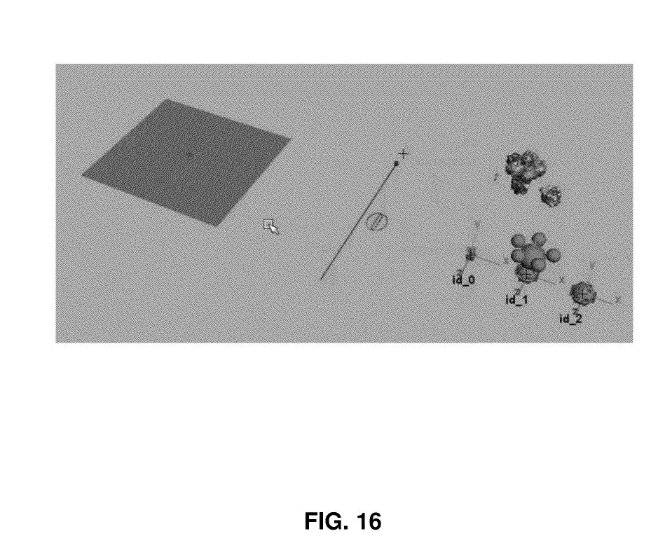

FIG. 16 illustrates bringing individual molecule models (themselves curated models) in to the membrane model. Animation engine 205 can populate the membrane with those molecules. There are different ways to accomplish this. For example, each phospholipid can be created as an instance of a phospholipid structure file that is rigged to allow appropriate rotation around bonds in the lipid tail. Alternatively, the phospholipids can be “drawn” as a set of strokes using, for example, a MEL or Python script. Transmembrane proteins and the membrane can be rigged to allow the proteins to float in the membrane and even displace laterally, if desired.

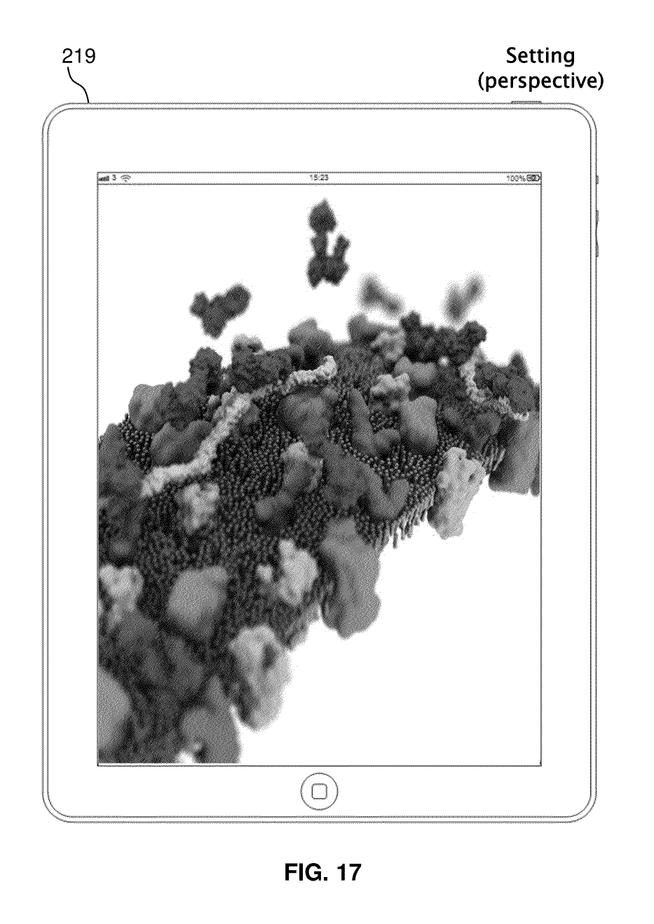

FIG. 17 illustrates the system output, i.e., use of an electronic device 219 to view a visualization product of the invention. The visualization product may include a rendered animation. That is, the 3D model and rigging of a rigged model 121 and any other inputs may be rendered into a bit-mapped based video clip. The rendered animation may be viewed on a screen of 1601.

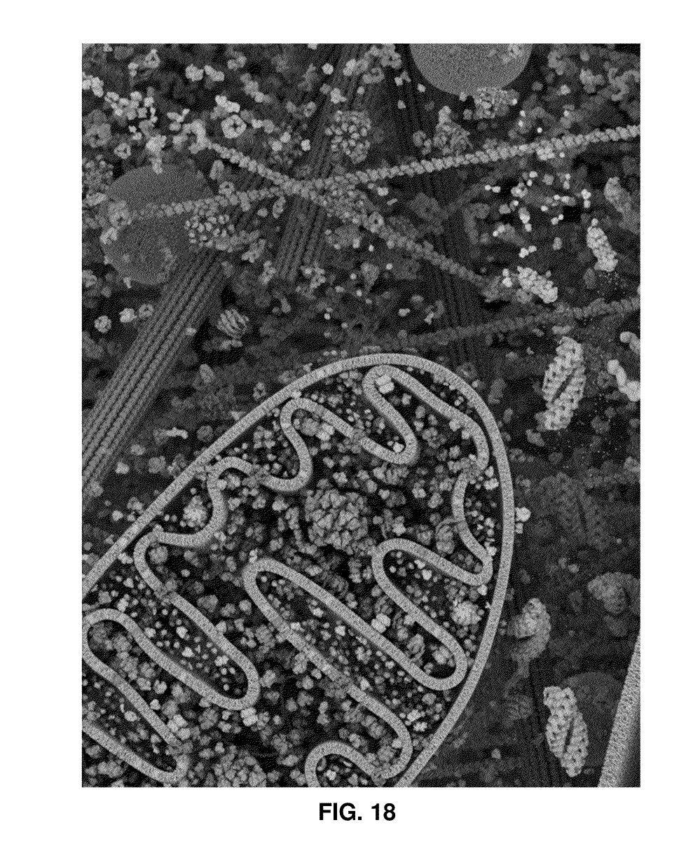

FIG. 18 gives another example of a visualization product that may be produced.

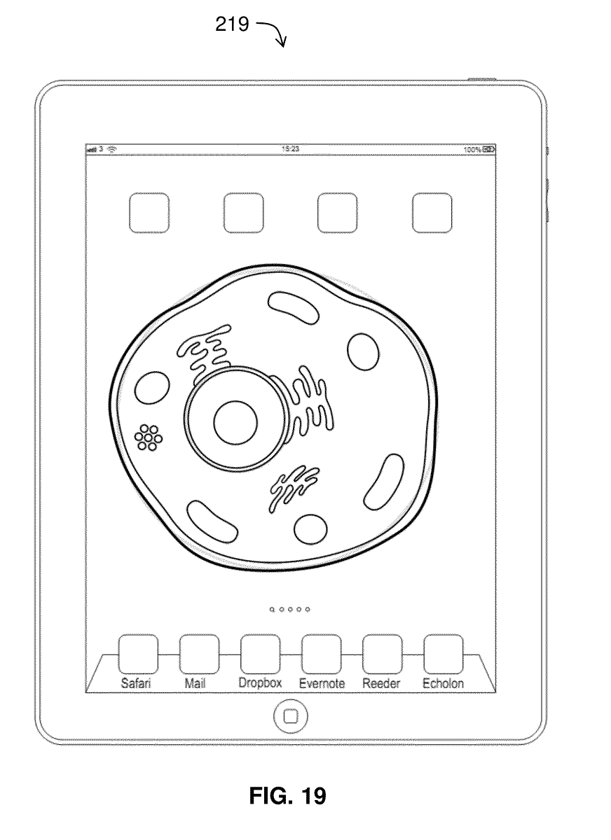

FIG. 19 illustrates the use of an electronic device 219 to interact with a model of a complex natural system such as a whole cell model. A whole cell model could be assembled from curated molecular models in the database. Systems and methods of the invention can be used to provide models that cover a substantial entirety of a complex natural system. For example, an ecological system such as the water cycle or population biology can be modeled. Astronomical and cosmological phenomenon such as energy and gravitational dynamics of galaxies and the space between them may be modeled. Organisms may be modeled, such as substantially all of the organ system in a body, or the development of an organism over time (e.g., embryonic stages). Neural networks and the architecture and function of the brain may be modeled. In certain embodiments, methods and systems of the invention are used to provide a visual cell.

One of skill in the art will recognize that digital assets/modules database 105 and curated model database 109 may be accessed via interaction through a computer system. Using a computer system, a 3D modeling/animation package like Maya, SoftImage, 3DStudioMax, modo etc., may be employed to produce a model, which may be deposited into the curated model database 109). Any suitable computer system may be used.

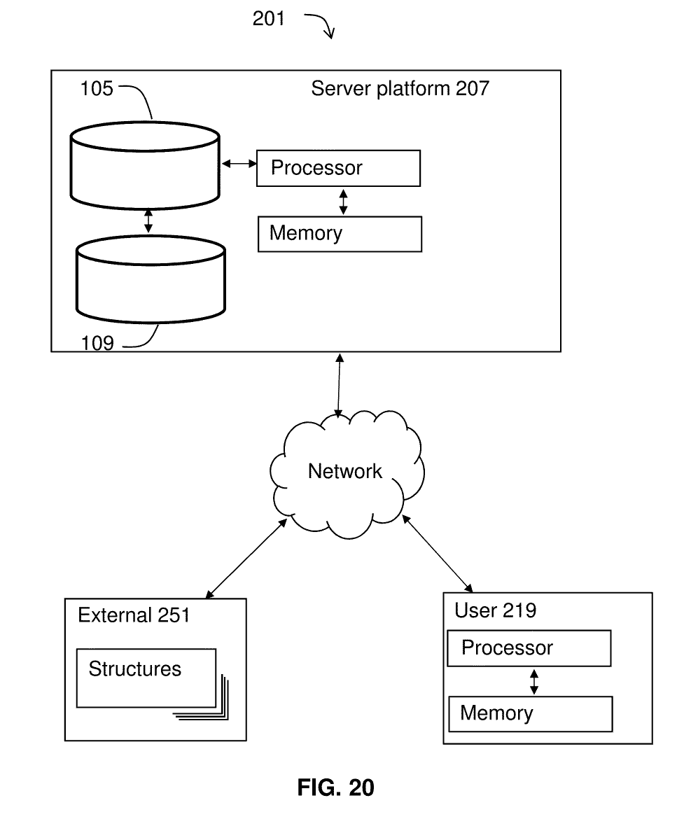

FIG. 20 illustrates components of a computer system 201 that may be included in systems of the invention. Generally, asset database 105 operates with the ability to connect to and pull from curated model database 109. Server platform 207 may be used to create curated models and populate model database 109. User computer 219 provides the web portal UI through which a user may give input for a visualization product. Material may be obtained from external server(s) 251. A computer generally refers to a device that includes a processor coupled to a non-transitory memory and an input output device. Computers of system 201 may communicate with one other via a network—broadly referring to the hardware used in transferring signals between computers. The network may be taken to include internet hardware such as telephone lines, cell towers, local switches and routers (e.g., LINKSYS products by Cisco Systems, Inc. (San Jose, Calif.), Ethernet cables, Wi-Fi cards, network interface cards, and other such device.

In certain embodiments, user computer 219 refers to the personal computer (e.g., tablet, laptop, or desktop) used by a consumer to log into system 201 and order, design, or put together a visualization project to communicate a scientific idea. A visualization product may include one or more of a picture, an animation, a simulation, a game, an interactive model, or other such media. Components of animations, simulations, and other interactive media can operate based on animation principles. Models such as PDB-based structures can be rigged and animated using animation and modeling software tools.

As described herein, system 201 provides a web portal and online service for products, software and tools in support of a community of graphics professionals, scientists, students and educators who use scientific visualization as a means to learn and communicate science. The system provides for improved understanding and teaching of science through accurate and engaging visuals. The system can be used to provide, for example, scientific visualization training courses e.g., using videos for users to watch at their own pace. The system can be operated so that videos are streamed to the user.

In some embodiments, the system is operable to provide a full curriculum. For example, units contained in a curriculum may include any one or more of:

Introduction to Biovisualization for Scientists

Preproduction Design—Introduction to Scientific Storyboarding

Preproduction Design—Advanced Scientific Storyboarding

Approaches to Molecular Simulation for Visualization

Working with mMaya's dsDNA kit

Introduction to iBooksAuthor

Advanced iBooksAuthor

Maya 101—Modeling

Maya 102—Surfacing

Maya 103—Animation

Maya 104—Dynamics

Intro to Compositing with After Effects

Introduction to Zbrush

Intermediate ZBrush

Animation & Dynamics in Maya

Constraints & Dynamic Parenting

DNA: Variations on a Theme

PaintFx Membranes

nCloth & Hair—Animating Mitosis

Rendering for Compositing

Global Illumination & Ambient Occlusion

Embodiments of the system allow visualization products to be created for any suitable audience.

The audience may be any single person or group of people with any education level, and the invention addresses unmet needs for a variety of different audience types or education levels. The audience may be of a collegiate or post-collegiate level, which may include for example, graduate, medical, post-doctoral or any other level. Content may be provided that is relevant to pre-collegiate, undergraduate, graduate, medical school and post-doctoral. For example, high-school students (e.g., in AP Biology) may be educated through the use of visual products such as standards-based mini-curricula in life sciences or other engaging digital modules contextualized in 3D environment. Such visual products provide support for the teachers as well as the students. A mini curriculum may include, for example, an assessment integrated with curriculum modules in the form of a digital asset as described herein. Using methods herein, it is possible to customize a visual style across collections. Generally a module is a singular digital learning asset or “widget”, and can be of a number of different types of media such as static or interactive images or diagrams, interactives, or mini-games, for example. A visual mini-curriculum can be made of a grouping of modules that address traditional curriculum topics. A collection may include a grouping of modules that belong together based on scientific topic, but not necessarily assembled in an education, curricular context like a mini-curriculum. In certain embodiments, systems and methods of the invention provide for collaborative learning. For example, content may be tailored to support paired, or groups of, students on projects. Material may be delivered such that tasks or response prompts are directed to members of a pair or group to support collaborative learning objectives.

The concept of a digital, visual mini-curriculum may find value in visual products provided for college students. For example, pre-med students can learn anatomy and physiology concepts. For working research scientists, there is a need for the ability to provide scientifically accurate visualizations in which static or animated visuals are derived from actual datasets. Scientists may require a clear provenance of datasets used for a visualization. Visual products as described herein may be used by scientists to illustrate and understand competing models for mechanisms. The general public may be well-served by books, articles, TV shows and documentaries that include scientifically accurate visualizations tailored to the average education level of the general public within a market segment. A society may be better informed and able to bring a fundamental understanding of science to future careers. A mini-curriculum will generally include educational materials and preferably includes tools for assessment.

One benefit of a mini-curriculum of the invention is that, due to the visual nature of the products provided by the invention, the curriculum need not be interwoven with prose exposition as required by convention for existing textbooks and journal articles. While a visual product may include some text (e.g., as captions, labels, or navigational instructions), in some embodiments, products of the invention are substantially visual, which can be taken to mean that the products do not include or require expository paragraphs of text for understanding. A visual curriculum has benefits due to the fact that many people learn in different styles and also that many scientific concepts are conducive to teaching visually. Additionally, a visual mini-curriculum is easier to distribute to audiences with different languages, since chapters of text do not need to be translated.

A mini-curriculum generally defines teaching material in that content is organized according to some pedagogical principle. For example, it may be determined that it is preferable to teach DNA replication prior to teaching mutation, and all prior to teaching population genetic concepts relating to diversity but after teaching Mendelian genetics. Accordingly, a visualization product may be prepared that includes, and indeed centers on, replication and reproduction as the molecular basis for inheritance, but the visualization product may follow a sequence that begins with Punnett square before giving the molecular mechanisms of diploid genetics. The sequence may end with illustrations linking the inherited alleles to populations in a geographical context.

To give an alternative example, a mini-curriculum may be prepared that presents a visualization of a molecular process such as apoptosis but the pedagogical organization may include assessment actions built in to the visualization and linked to certain parts of the illustrated apoptosis mechanism. The assessment tool could be, for example, an on-screen test (e.g., click a multiple-choice answer to proceed). In certain embodiments, the assessment tool is embedded as an interaction requiring a viewer to influence the depicted scene in the scientifically correct mechanism. In certain embodiments, assessment includes visual aspects and a user's progress is assessed visually. A user may interact with a visual display to satisfy an assessment (e.g., drag and drop the appropriate molecule given context). In this way, visual assessment can capture the assessment of a user.

The visual assessment embodiments are included but not limited to: 1) allowing student to visually modify existing imagery (either through labeling, additional sketching, selection or other activities), 2) order sets of still images or image sequences (animations) to properly sequence a temporal process, 3) create their own custom imagery within the system, control parameters that impact the quantitative and/or qualitative output of simulations and game-like interactives.

Systems and methods of the invention not only allow instructors to monitor student progress and understanding within and across individual assets, but they also enable/guide them in implementing asset-based activities in a flipped-classroom context. For example, aspects of certain digital assets are designed to be used by students at home for instructional purposes, while other aspects of these assets are designed to facilitate classroom-based discussions and problem solving.

The invention offers a new level of transparency to users that is realized at two levels: a) the sources used for creation of content in all form (structural, dynamic or other) and b) the process and methodology used to create the visualization itself.

Systems and methods of the invention provide for rapid updating of content based on changing scientific data or shifting theories within the scientific community. The system designed to allow revisions within digital assets as well as deletion or creation of entirely new digital assets.

Assessment materials may be provided with or within visual products. For example, a visualization may be accompanied by a test that prompts a user to make a series of answers in an extrinsic medium. In this example, a user could provide written answers outside of the system while accessing a visual product. This allows the assessment tool to provide standardized extrinsic results that can be compared against results from other methods (e.g., filled-in scantron sheets). In certain embodiments, assessments are adaptive and embedded within a visual product. For example, in illustrating a molecular biology reaction, a user may have to drag the appropriate molecule into a scene, e.g., from a palette of candidate molecules. Preferably, the assessment can aid in evaluating a student by, for example, measuring progress through educational objectives.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for providing a visualization product, the method comprising:
receiving, to a server system, input from a user that identifies one or more biological entities and a biological concept involving the one or more biological entities;
constructing, by the server system, a visualization product that comprises at least one digital asset and that visually conveys the biological concept showing a visualization of the biological entities, wherein the server system constructs the visualization product automatically; and
outputting, to a user device, a displayable form of the visualization product for viewing by the user.

2. The method of claim 1, wherein the visualization comprises an interaction.

3. The method of claim 1, wherein the digital asset comprises a structure and a rig that defines animation dynamics for the structure.

4. The method of claim 1, wherein the input is received, and the display is output, through a web portal provided by the server system for use by the user.

5. The method of claim 1, wherein the input from the user further comprises instructions for tailoring the visualization product.

6. The method of claim 5, wherein tailoring the visualization product comprises using additional assets to depict a biological context for the one or more biological entities.

7. The method of claim 1, wherein constructing the visualization product comprises selecting a plurality of digital assets that includes the at least one digital asset for use in constructing in the visualization product.

8. The method of claim 1, wherein the input from the user further comprises a selection of a setting for the display and further wherein the user device provides the display according to the selected setting.

9. The method of claim 8, wherein the setting for the display comprises one selected from the list consisting of: perspective, an animation setting, and a color setting.

10. The method of claim 1, wherein the digital asset comprises a structure and a rig that defines animation dynamics for the structure and constructing the visualization product comprises selecting the rig from a group of alternative riggings.

11. The method of claim 1, wherein the visualization product comprises an animation or simulation depicting an interaction of at least two biological entities.

12. A system for providing a visualization product, the system comprising:
a processor coupled to a memory containing instructions executable by the processor to cause the system to:
receive input from a user that identifies one or more biological entities and a biological concept involving the one or more biological entities;
construct a visualization product that comprises at least one digital asset and that visually conveys the biological concept showing an interaction of the biological entities, wherein the server system constructs the visualization product automatically; and
output, to a user device, a displayable form of the visualization product for viewing by the user.

13. The system of claim 12, wherein the digital asset comprises a structure and a rig that defines animation dynamics for the structure.

14. The system of claim 12, wherein the system provides a web portal for use by the user and further wherein the system receives the input and outputs the display through the web portal.

15. The system of claim 12, wherein the input from the user further comprises instructions for tailoring the visualization product.

16. The system of claim 15, wherein the system tailors the visualization product by using additional assets to depict a biological context for the one or more biological entities.

17. The system of claim 12, wherein the system selects a plurality of digital assets that includes the at least one digital asset for use in constructing in the visualization product.

18. The system of claim 12, wherein the input from the user further comprises a selection of a setting for the display and further wherein the user device provides the display according to the selected setting.

19. The system of claim 18, wherein the setting for the display comprises one selected from the list consisting of: perspective, an animation setting, and a color setting.

20. The system of claim 12, wherein the digital asset comprises a structure and a rig that defines animation dynamics for the structure and further wherein the system selects the rig from a group of alternative riggings.

21. The system of claim 12, wherein the visualization product comprises an animation or simulation depicting an interaction of at least two biological entities.
